(19) United States
(12) Patent Application Publication
(10) Pub. No.: US 2020/0250064 A1
(43) Pub. Date: Aug. 6, 2020

(54) INFORMATION PROCESSING APPARATUS AND DISTRIBUTED PROCESSING SYSTEM

(71) Applicant: FUJITSU LIMITED, Kawasaki-shi (JP)

(72) Inventor: Kento Ikkaku, Kawasaki (JP)

(73) Assignee: FUJITSU LIMITED, Kawasaki-shi (JP)

(21) Appl. No.: 16/747,918

(22) Filed: Jan. 21, 2020

(30) Foreign Application Priority Data
Feb. 1, 2019 (JP) 2019-017514

(51) Int. Cl. G06F 11/34; H04L 29/08; G06F 11/30

(52) U.S. Cl. CPC G06F 11/3423; H04L 67/322; H04L 67/325; G06F 11/3006; H04L 67/10

(57) ABSTRACT

An information processing apparatus calculates a process execution time, for each of nodes, in which one or more processes to be allocated to the node are performed in the node, select a first node group that includes one or more nodes in an order from the node with a calculated longest process execution time, select a second node group that includes one or more nodes to which processes of the first node group are allocated among remaining nodes excluding the first node group from the nodes, calculate a sum of the process execution time in each of combinations of nodes of the first node group and the second node group and an adjustment time that each of the processes is allocated to any one of the nodes, and determine any one of the combinations as an adjustment target, based on the sum calculated for each of the combinations.

### CROSS-REFERENCE TO RELATED APPLICATION

This application is based upon and claims the benefit of the prior Japanese Patent Application No. 2019-017514, filed on Feb. 1, 2019, the entire contents of which are incorporated herein by reference.

### FIELD

The embodiments discussed herein are related to an information processing apparatus and a distributed processing system.

### BACKGROUND

There is a distributed processing system of the related art that includes a plurality of nodes, executes an analysis process using data stored in each of the nodes in a distributed manner to the plurality of nodes, and transmits the results of the analysis process to a user terminal device. The nodes are, for example, servers or data centers.

As the prior art, for example, there is a technique for making a response to whether a process may be accepted by referring to the upper limit value and the current value of a process load of the own node. In addition, for example, there is a technique for specifying a computer having a load margin based on load information of the own computer and load information of another computer group.

Related techniques are disclosed in, for example, Japanese Laid-Open Patent Publication Nos. 2005-004676 and 10-078937.

### SUMMARY

According to an aspect of the embodiments, an information processing apparatus includes a memory, and a processor coupled to the memory and the processor configured to, when each of a plurality of processes is allocated to any one of a plurality of nodes, calculate a process execution time, for each of the plurality of nodes, in which one or more processes of the plurality of processes to be allocated to the any one of a plurality of nodes is performed in the node of the plurality of nodes, select a first node group that includes one or more nodes of the plurality of nodes in an order from the node with a calculated longest process execution time among the plurality of nodes, select a second node group that includes one or more nodes of the plurality of nodes to which processes of the first node group are allocated among remaining nodes excluding the first node group from the plurality of nodes, calculate a sum of the process execution time in each of a plurality of combinations of the node of the first node group and the node of the second node group and an adjustment time that each of the plurality of processes is allocated to any one of the plurality of nodes, and determine any one of the plurality of combinations as an adjustment target, based on the sum calculated for each of the plurality of combinations.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of a distributed processing method according to an embodiment;

FIG. 2 is an explanatory view illustrating an example of a distributed processing system 200;

FIG. 3 is an explanatory view illustrating an example of use of the distributed processing system 200;

FIG. 4 is a block diagram illustrating a hardware configuration example of an information processing apparatus 100;

FIG. 5 is a block diagram illustrating a hardware configuration example of an edge server 201;

FIG. 6 is a block diagram illustrating a functional configuration example of the information processing apparatus 100;

FIG. 7 is an explanatory view (part 1) of operation example 1 of the information processing apparatus 100;

FIG. 8 is an explanatory view (part 2) of operation example 1 of the information processing apparatus 100;

FIG. 9 is an explanatory view (part 3) of operation example 1 of the information processing apparatus 100;

FIG. 10 is an explanatory view (part 4) of operation example 1 of the information processing apparatus 100;

FIG. 11 is an explanatory view (part 5) of operation example 1 of the information processing apparatus 100;

FIG. 12 is a flowchart (part 1) illustrating an example of the entire processing procedure in operation example 1;

FIG. 13 is a flowchart (part 2) illustrating an example of the entire processing procedure in operation example 1;

FIG. 14 is an explanatory view (part 1) of operation example 2 of the information processing apparatus 100;

FIG. 15 is an explanatory view (part 2) of operation example 2 of the information processing apparatus 100;

FIG. 16 is an explanatory view (part 3) of operation example 2 of the information processing apparatus 100;

FIG. 17 is an explanatory view (part 4) of operation example 2 of the information processing apparatus 100;

FIG. 18 is an explanatory view (part 5) of operation example 2 of the information processing apparatus 100;

FIG. 19 is a flowchart (part 1) illustrating an example of the entire processing procedure in operation example 2;

FIG. 20 is a flowchart (part 2) illustrating an example of the entire processing procedure in operation example 2; and

FIG. 21 is a flowchart (part 3) illustrating an example of the entire processing procedure in operation example 2.

### DESCRIPTION OF EMBODIMENTS

When processes are executed in a distributed manner by a plurality of nodes, it is difficult to reduce the time required to obtain a processing result. For example, a method of reducing the execution time of an analysis process by performing an allocation adjustment of a plurality of processes obtained by dividing the analysis process to a plurality of nodes is conceivable. In this method, while the execution time of the analysis process is reduced, the time required for the adjustment increases as the number of nodes increases, and accordingly, the time required to obtain a result of the analysis process may not be reduced.

Hereinafter, an embodiment of a technique capable of reducing the time required to obtain a processing result when a process is executed in a distributed manner will be described in detail with reference to the accompanying drawings.

[Example of Distributed Processing Method According to Embodiment]

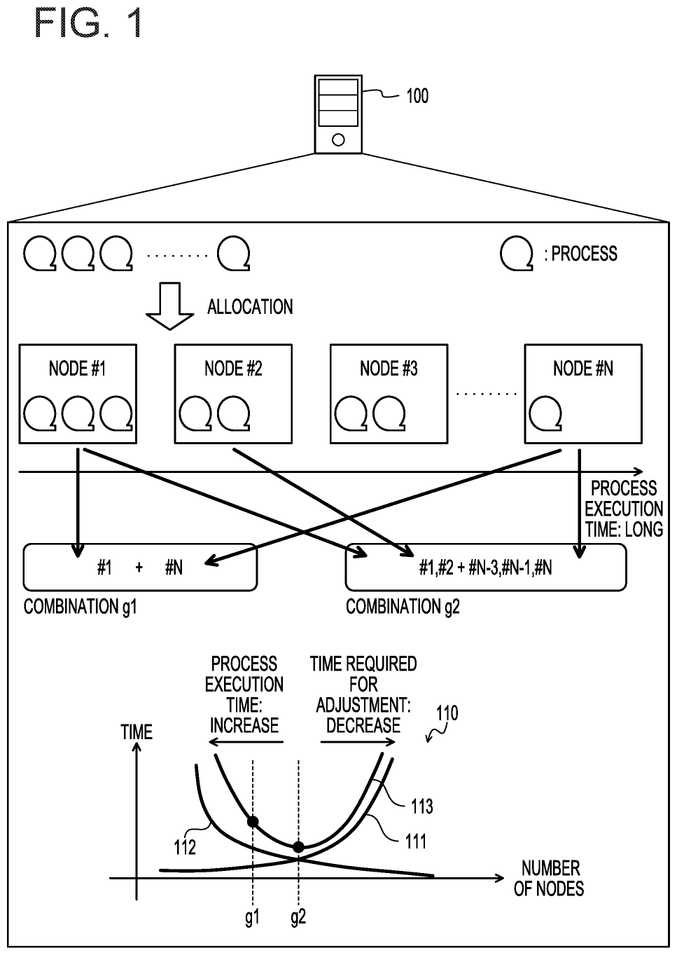

FIG. 1 is an explanatory view illustrating an example of a distributed processing method according to an embodiment. An information processing apparatus 100 is a computer that controls a distributed processing system.

The distributed processing system includes a plurality of nodes, a plurality of processes forming a predetermined process using data stored in each of the nodes are executed in a distributed manner by the plurality of nodes, and a result of the predetermined process is transmitted to a user terminal device. The node is, for example, a server or a data center. Each of the plurality of processes is, for example, a task.

Here, for example, as a method in which a plurality of processes are executed in a distributed manner by a plurality of nodes, it is conceivable that each of the plurality of processes is allocated to a node having data to be used by the process among the plurality of nodes, and the plurality of processes are executed in a distributed manner by the plurality of nodes.

However, with this method, it is difficult to reduce the time required to obtain the result of the predetermined process when the plurality of processes forming the predetermined process are executed in a distributed manner by the plurality of nodes. For example, the plurality of nodes have different amounts of computation resources, different bandwidths, different data amounts, from each other, and the like. For this reason, the process execution time required until the execution of the allocated process is completed in each of the plurality of nodes tends to be uneven among the nodes. Therefore, a node having the longest process execution time becomes a bottleneck, which makes it difficult to reduce the process execution time required until the predetermined process is completed. As a result, it is difficult to reduce the time required to obtain a result of the predetermined process.

Meanwhile, a method of reducing the process execution time required until the execution of a predetermined process is completed by performing an allocation adjustment of a plurality of processes forming the predetermined process to a plurality of nodes is conceivable. The adjustment is performed, for example, by searching for an allocation pattern that minimizes the process execution time required until the execution of the predetermined process is completed by using all combinations of allocation patterns. Specifically, Mesos or the like is used for the adjustment.

Even with this method, it is difficult to reduce the time required to obtain a result of the predetermined process when the plurality of processes forming the predetermined process are executed in a distributed manner by the plurality of nodes. For example, in this method, while the process execution time required until the execution of the predetermined process is completed is reduced, the time required for the adjustment increases as the number of nodes included in the distributed processing system increases. At this time, the time required for the adjustment may exceed the process execution time required until the execution of the predetermined process is completed, by the reduced amount. As a result, it is difficult to reduce the time required to obtain a result of the predetermined process.

Therefore, in this embodiment, descriptions will be made on a distributed processing method that is capable of considering a balance between the process execution time required to complete the execution of a predetermined process and the time required for allocation adjustment of a plurality of processes forming the predetermined process to a plurality of nodes. According to the distributed processing method, when the plurality of processes forming the predetermined process are executed in a distributed manner by the plurality of nodes, it is possible to reduce the time required to obtain a result of the predetermined process.

In FIG. 1, (1-1) when each of a plurality of processes forming a predetermined process is allocated to any one of a plurality of nodes, the information processing apparatus 100 calculates the process execution time in each of the plurality of nodes. In the example of FIG. 1, when each of the plurality of processes is allocated to node #1, node #2, node #3, . . . , node # N, respectively, the information processing apparatus 100 calculates the process execution time in each of node #1, node #2, node #3, . . . , node # N. Here, for the purpose of simplification of explanation, a case where the calculated process execution time is large in an order from node #1 will be described as an example.

(1-2) The information processing apparatus 100 specifies a plurality of combinations formed by selecting nodes that are candidates for process allocation adjustment. Each of the combinations is a node group that selects one or more nodes in an order from a node with the calculated longest process execution time among the plurality of nodes, and one or more movement destination nodes which move the processes of the one or more nodes among the remaining nodes excluding the one or more nodes from the plurality of nodes. When performing the process allocation adjustment for each of the specified combinations, the information processing apparatus 100 calculates a sum of the process execution time in the combination and the time required for the adjustment.

In the example of FIG. 1, the information processing apparatus 100 specifies a combination g1 that selects node #1 and node # N that is a movement destination among the remaining nodes in an order from a node having the longest process execution time. For the combination g1, the information processing apparatus 100 calculates the sum of the process execution time in the combination g1 and the time required for the adjustment when the process allocation adjustment is performed. In addition, the information processing apparatus 100 specifies a combination g2 that selects node #1, node #2, and node # N−2, node # N−1, and node # N that are the movement destinations among the remaining nodes in an order from the node having the longest process execution time. For the combination g2, the information processing apparatus 100 calculates the sum of the process execution time in the combination g2 and the time required for the adjustment when the process allocation adjustment is performed.

Here, since the range in which the process allocation adjustment is performed becomes narrower as the number of nodes included in a combination decreases, the process execution time in the combination tends to increase. A relationship between the number of nodes included in the combination and the process execution time in the combination may be represented by a characteristic curve 111 of a graph 110. Meanwhile, since the number of allocation patterns used for all combinations in the adjustment increases as the number of nodes included in the combination increases, the time required for the adjustment tends to increase. A relationship between the number of nodes included in the combination and the time required for the adjustment may be represented by a characteristic curve 112 of the graph 110.

Here, taking the characteristic curves 111 and 112 into consideration, when the process execution time in the combination and the time required for the adjustment are reduced in a well-balanced manner, as a contribution of a combination to the reduction in the time required until a result of the predetermined process is obtained becomes greater, the sum becomes smaller. A relationship between the number of nodes included in the combination and the sum of the process execution time and the time required for adjustment in the combination may be represented by a characteristic curve 113 of the graph 110.

(1-3) The information processing apparatus 100 determines any one of the plurality of combinations as an adjustment target based on the sum calculated for each combination. In the example of FIG. 1, the information processing apparatus 100 determines the combination g2 having a smaller sum among the combinations g1 and g2 as an adjustment target. Thus, when the plurality of processes forming the predetermined process are executed in a distributed manner by the plurality of nodes, the information processing apparatus 100 may reduce the time required until the result of the predetermined process is obtained.

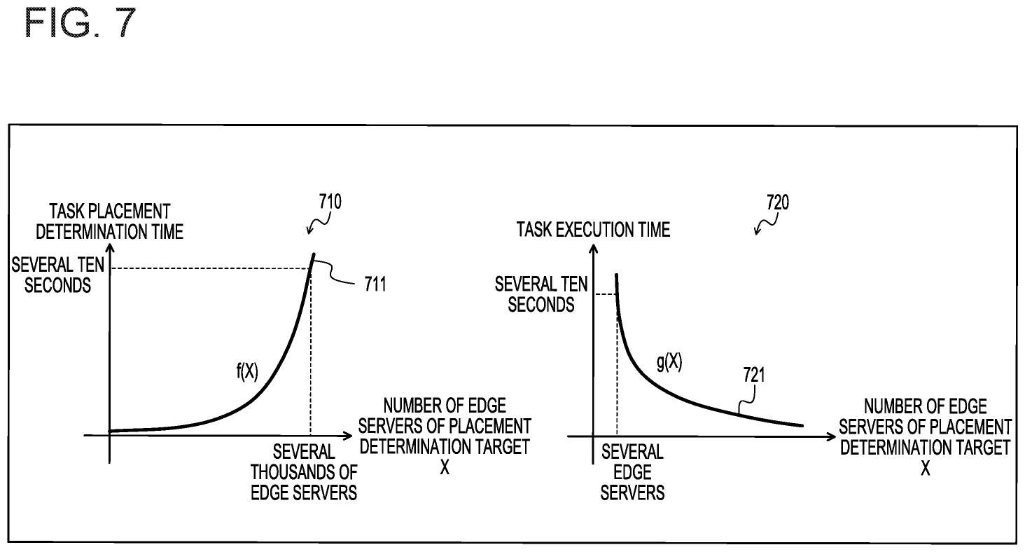

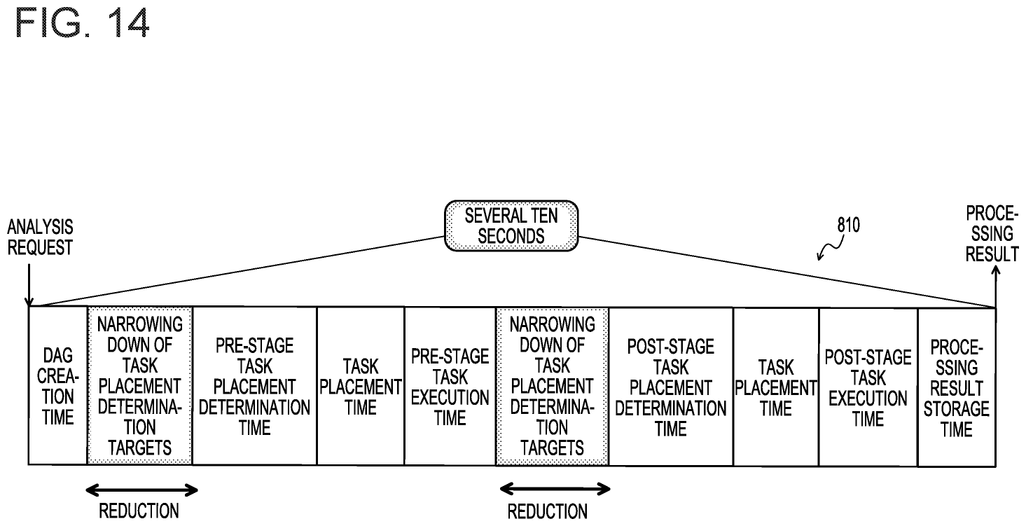

Here, a case has been described in which the information processing apparatus 100 specifies a plurality of combinations at a time and determines an adjustment target. However, the present disclosure is not limited thereto. For example, the information processing apparatus 100 may search for a combination that is determined as an adjustment target while increasing the number of combinations. An operation example of the information processing apparatus 100 in this case specifically corresponds to operation example 1 (to be described later with reference to FIGS. 7 to 11), operation example 2 (to be described later with reference to FIGS. 14 to 18), or the like.

[Example of Distributed Processing System 200]

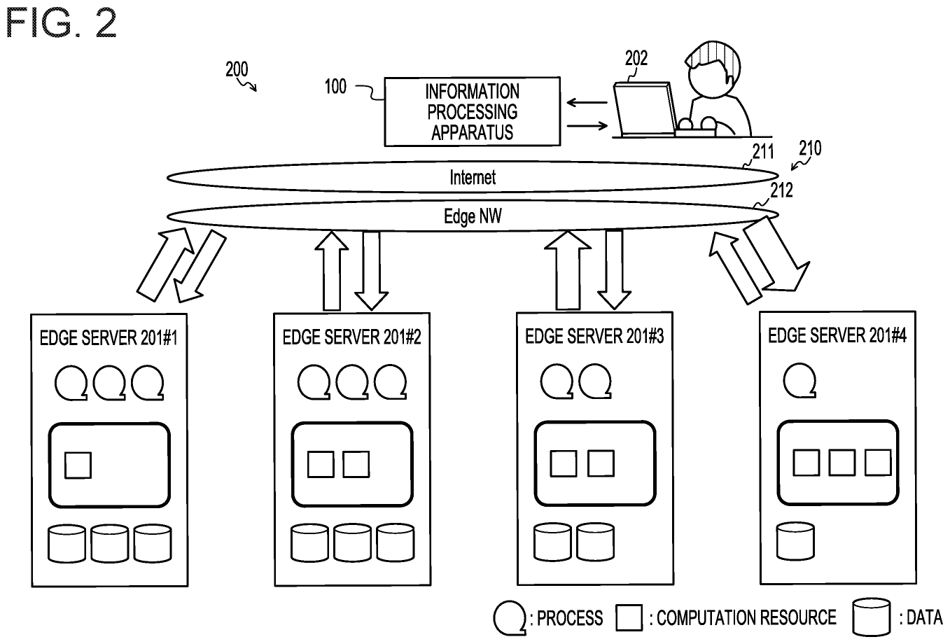

Next, an example of a distributed processing system 200 to which the information processing apparatus 100 illustrated in FIG. 1 is applied will be described with reference to FIG. 2.

FIG. 2 is an explanatory view illustrating an example of the distributed processing system 200. In FIG. 2, the distributed processing system 200 includes an information processing apparatus 100, a plurality of edge servers 201, and a user terminal device 202. In the following description, when the plurality of edge servers 201 are distinguished from each other, a certain edge server 201 may be expressed as an “edge server 201# i” using the ID “# i” (i is a natural number) of the edge server 201.

In the distributed processing system 200, the information processing apparatus 100 and the edge server 201 are interconnected via a wired or wireless network 210. The network 210 is, for example, the Internet 211, an Edge NW (NetWork) 212, or the like. Further, the information processing apparatus 100 and the user terminal device 202 are interconnected either by wire or wireless. The information processing apparatus 100 and the user terminal device 202 may be interconnected via the network 210.

The information processing apparatus 100 is, for example, a computer that receives a query from the user terminal device 202 and allocates a plurality of tasks forming a predetermined process requested to be executed by the query to the plurality of edge servers 201. The predetermined process is, for example, an analysis process using data of the edge servers 201. The analysis process is, for example, a session log analysis process, a server health analysis process, or the like. The information processing apparatus 100 transmits, for example, a result of the predetermined process to the user terminal device 202 based on the processing results of the plurality of tasks.

Here, for example, when allocating the plurality of tasks to the plurality of edge servers 201, the information processing apparatus 100 adjusts the task allocation to reduce the time required for the predetermined process itself. In the following description, the task allocation adjustment may be referred to as a “task placement determination”. Further, the information processing apparatus 100 narrows down task allocation determination targets in the task placement determination to reduce the time required for the task placement determination. The information processing apparatus 100 reduces the time required for obtaining a result of the predetermined process by reducing the time required for the predetermined process itself and reducing the time required for the task placement determination. The information processing apparatus 100 is, for example, a server, a PC (Personal Computer), or the like.

The edge server 201 is, for example, a computer that operates as a node illustrated in FIG. 1. The edge server 201 stores, for example, data. The data is collected from, for example, an IoT (Internet of Things) device. The data may be detected by, for example, the edge server 201. The edge server 201 has, for example, one or more computation resources. The computation resource is, for example, a CPU (Central Processing Unit).

The edge server 201 executes, for example, a task allocated to the own server using data of the own server by the computation resource of the own server. The edge server 201 stores task processing results. The amount of data may differ between edge servers 201. The amount of computation resources may differ between edge servers 201. A bandwidth may differ between edge servers 201.

The user terminal device 202 is a computer used by a user who uses the distributed processing system 200. The user terminal device 202 transmits a query requesting execution of the predetermined process to the information processing apparatus 100 based on, for example, a user's operation input. Further, the user terminal device 202 receives, for example, a result of the predetermined process from the information processing apparatus 100. The user terminal device 202 displays, for example, the received result of the predetermined process. The user terminal device 202 is, for example, a PC, a tablet terminal, a smartphone, or the like.

A case where the information processing apparatus 100 is an apparatus different from the user terminal device 202 has been described here. However, the present disclosure is not limited thereto. For example, the information processing apparatus 100 may operate as the user terminal device 202. In this case, the distributed processing system 200 may not include the user terminal device 202.

In addition, a case has been described here in which a task allocation destination is a single device, namely, the edge server 201. However, the present disclosure is not limited thereto. For example, the task allocation destination may be a set of devices such as a data center. The distributed processing system 200 may include both the edge server 201 and the data center.

[Use Example of Distributed Processing System 200]

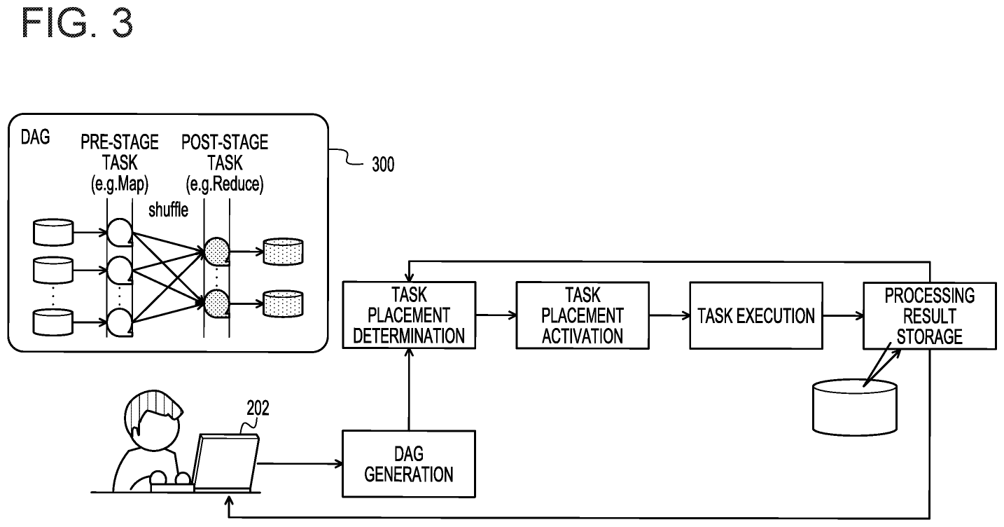

Next, an example of use of the distributed processing system 200 illustrated in FIG. 2 will be described with reference to FIG. 3.

FIG. 3 is an explanatory view illustrating an example of use of the distributed processing system 200. As illustrated in FIG. 3, a user uses the distributed processing system 200 by using the user terminal device 202 to transmit a query requesting an analysis process to the information processing apparatus 100. The query includes information defining the DAG (Directed Acrylic Graph).

The DAG is a graph illustrating tasks as nodes and data flows as branches. The DAG is, for example, a graph illustrating a plurality of pre-stage tasks, a plurality of post-stage tasks, and data flows based on a Map-Reduce programming model. Accordingly, the user may cause the distributed processing system 200 to perform a DAG generation, a task placement determination, a task placement activation, a task execution, and a processing result storage.

The user may cause the distributed processing system 200, for example, to perform a DAG generation. The user may cause the distributed processing system 200, for example, to refer to the DAG to perform a task placement determination, a task placement activation, a task execution, and a processing result storage for the plurality of pre-stage tasks. The user may cause the distributed processing system 200, for example, to refer to the DAG to perform a task placement determination, a task placement activation, a task execution, and a processing result storage for the plurality of post-stage tasks based on the processing results of the plurality of pre-stage tasks.

The task placement determination is an operation of determining the placement of a plurality of tasks forming a predetermined process with respect to a plurality of edge servers that are task placement determination targets. For example, the task placement determination is an operation of searching for all combinations of placement patterns in which tasks are placed in the plurality of edge servers as the task placement determination targets so as to minimize the task execution times in the plurality of edge servers as the task placement determination targets.

The task placement activation is an operation of placing the plurality of tasks in the plurality of edge servers included in the distributed processing system 200. The task execution is an operation in which the plurality of tasks are actually executed in a distributed manner by the plurality of edge servers included in the distributed processing system 200. The processing result storage is an operation of storing processing results, which are obtained when the plurality of tasks are executed in a distributed manner by the plurality of edge servers included in the distributed processing system 200, in a storage area.

[Hardware Configuration Example of Information Processing Apparatus 100]

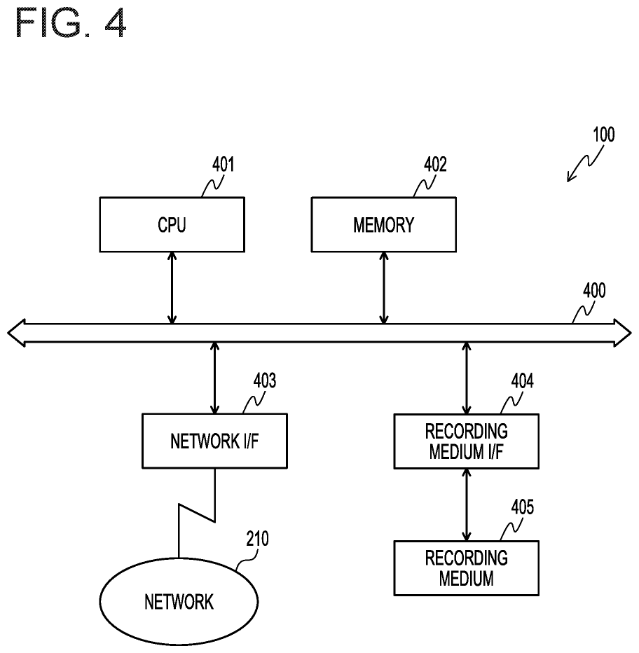

Next, an example of the hardware configuration of the information processing apparatus 100 will be described with reference to FIG. 4.

FIG. 4 is a block diagram illustrating an example of the hardware configuration of the information processing apparatus 100. As illustrated in FIG. 4, the information processing apparatus 100 includes a CPU 401, a memory 402, a network I/F (Interface) 403, a recording medium I/F 404, and a recording medium 405, which are interconnected by a bus 400.

Here, the CPU 401 governs the entire control of the information processing apparatus 100. The memory 402 includes, for example, a ROM (Read Only Memory), a RAM (Random Access Memory), a flash ROM, and the like. Specifically, for example, a flash ROM or a ROM stores various programs, and a RAM is used as a work area of the CPU 401. The programs stored in the memory 402 are loaded onto the CPU 401 to cause the CPU 401 to execute coded processes.

The network I/F 403 is connected to the network 210 via a communication line and is connected to other computers via the network 210. The network I/F 403 governs internal interfacing with the network 210 and controls input/output of data from other computers. The network I/F 403 is, for example, a modem, a LAN (Local Area Network) adapter, or the like.

The recording medium I/F 404 controls reading/writing of data from/in the recording medium 405 according to control of the CPU 401. The recording medium I/F 404 is, for example, a disk drive, an SSD (Solid State Drive), a USB (Universal Serial Bus) port, or the like. The recording medium 405 is a nonvolatile memory that stores data written under control of the recording medium I/F 404. The recording medium 405 is, for example, a disk, a semiconductor memory, a USB memory, or the like. The recording medium 405 may be detachable from the information processing apparatus 100.

The information processing apparatus 100 may include, for example, a keyboard, a mouse, a display, a printer, a scanner, a microphone, a speaker, and the like in addition to the components described above. Further, the information processing apparatus 100 may include a plurality of recording media I/F 404 and a plurality of recording media 405. Further, the information processing apparatus 100 may not include the recording medium I/F 404 and the recording medium 405.

[Hardware Configuration Example of Edge Server 201]

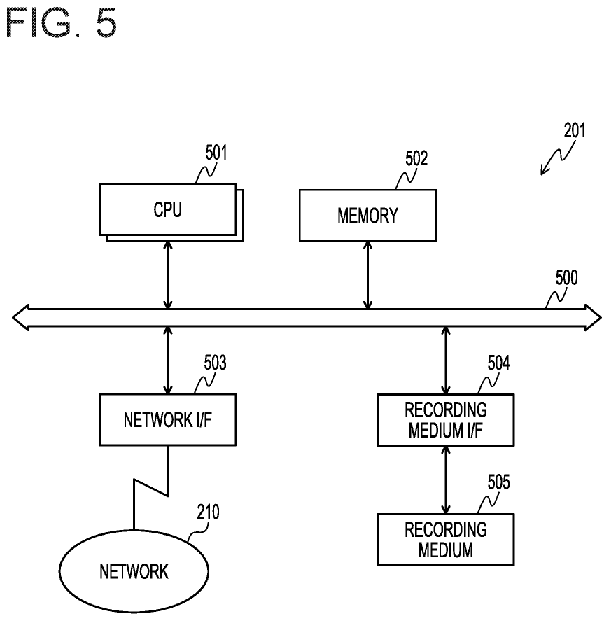

Next, an example of the hardware configuration of the edge server 201 will be described with reference to FIG. 5.

FIG. 5 is a block diagram illustrating an example of the hardware configuration of the edge server 201. As illustrated in FIG. 5, the edge server 201 includes one or more CPUs 501, a memory 502, a network I/F 503, a recording medium I/F 504, and a recording medium 505, which are interconnected by a bus 500.

Here, each CPU 501 governs the entire control of the edge server 201. The memory 502 includes, for example, a ROM, a RAM, a flash ROM, and the like. Specifically, for example, a flash ROM or a ROM stores various programs, and a RAM is used as a work area of the CPU 501. The programs stored in the memory 502 are loaded onto the CPU 501 to cause the CPU 501 to execute coded processes.

The network I/F 503 is connected to the network 210 via a communication line and is connected to other computers via the network 210. The network I/F 503 governs internal interfacing with the network 210 and controls input/output of data from the other computers. The network I/F 503 is, for example, a modem, a LAN adapter, or the like.

The recording medium I/F 504 controls reading/writing of data from/in the recording medium 505 according to control of the CPU 501. The recording medium I/F 504 is, for example, a disk drive, an SSD, a USB port, or the like. The recording medium 505 is a nonvolatile memory that stores data written under control of the recording medium I/F 504. The recording medium 505 is, for example, a disk, a semiconductor memory, a USB memory, or the like. The recording medium 505 may be detachable from the edge server 201.

The edge server 201 may include, for example, a keyboard, a mouse, a display, a printer, a scanner, a microphone, a speaker, and the like in addition to the components described above. Further, the edge server 201 may include a plurality of recording media I/F 504 and a plurality of recording media 505. Further, the edge server 201 may not include the recording medium I/F 504 and the recording medium 505.

[Functional Configuration Example of Information Processing Apparatus 100]

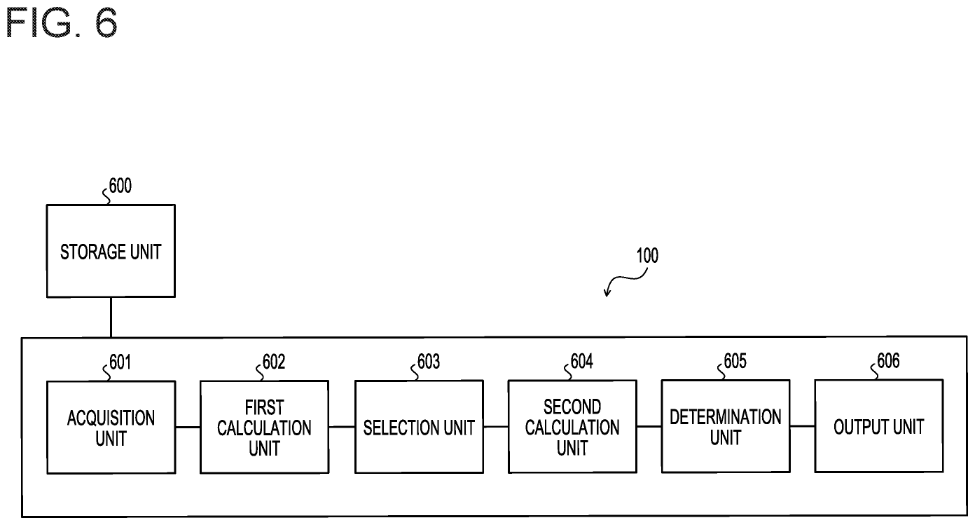

Next, an example of the functional configuration of the information processing apparatus 100 will be described with reference to FIG. 6.

FIG. 6 is a block diagram illustrating an example of the functional configuration of the information processing apparatus 100. The information processing apparatus 100 includes a storage unit 600, an acquisition unit 601, a first calculation unit 602, a selection unit 603, a second calculation unit 604, a determination unit 605, and an output unit 606.

The storage unit 600 is implemented by a storage area such as the memory 402 or the recording medium 405 illustrated in FIG. 4. In the following, a case where the storage unit 600 is included in the information processing apparatus 100 will be described. However, the present disclosure is not limited thereto. For example, the storage unit 600 may be included in an apparatus different from the information processing apparatus 100, and the storage content of the storage unit 600 may be referred to from the information processing apparatus 100.

The acquisition unit 601, the first calculation unit 602, the selection unit 603, the second calculation unit 604, the determination unit 605, and the output unit 606 function as examples of a controller. Specifically, the acquisition unit 601, the first calculation unit 602, the selection unit 603, the second calculation unit 604, the determination unit 605, and the output unit 606 implement their functions, for example, by causing the CPU 401 to execute programs stored in the storage area such as the memory 402 or the recording medium 405 illustrated in FIG. 4. The processing result of each functional unit is stored in the storage area such as the memory 402 or the recording medium 405 illustrated in FIG. 4.

The storage unit 600 stores various types of information that is referred to or updated in the processing of each functional unit. The storage unit 600 stores, for example, a parameter of each of a plurality of nodes. The node is, for example, the edge server 201 illustrated in FIG. 2. The parameter is, for example, the amount of available computation resource of the node. The computation resource is, for example, the CPU 501. The parameter is, for example, the size of a node bandwidth. The storage unit 600 stores, for example, the type and amount of data stored in each of the plurality of nodes.

The storage unit 600 stores, for example, an actual measurement value of time required for allocation adjustment of a process for each node number to be subjected to the process allocation adjustment. The process is, for example, a task. The storage unit 600 stores, for example, the process execution time taken for a single process and the data amount used by a single process. Specifically, the storage unit 600 stores the task execution time of a single task and the data amount used by a single task. Hereinafter, in the description of the acquisition unit 601, the first calculation unit 602, the selection unit 603, the second calculation unit 604, the determination unit 605, and the output unit 606, a case where the process is a “task” will be described as an example.

The acquisition unit 601 acquires various types of information to be used for processing of each functional unit. The acquisition unit 601 stores the acquired various types of information in the storage unit 600 or outputs the information to each functional unit. The acquisition unit 601 may output the various types of information stored in the storage unit 600 to each functional unit. For example, the acquisition unit 601 acquires various types of information based on a user's operation input. For example, the acquisition unit 601 may receive various types of information from an apparatus different from the information processing apparatus 100.

The first calculation unit 602 calculates the task execution time in each of the plurality of nodes when each of the plurality of tasks is allocated to any one of the plurality of nodes. The task execution time in a node is the time required to complete execution of one or more tasks allocated to the node. The task execution time in a node to which no task is allocated may be zero.

For example, the first calculation unit 602 calculates the task execution time in each node when each task is allocated to a node having data to be used by the task. Specifically, based on the amount of computation resource possessed by each node, the first calculation unit 602 calculates the task execution time in each node when each task is allocated to a node having data to be used by the task.

More specifically, based on a result of dividing the number of tasks allocated to the node by the amount of computation resource possessed by the node, the first calculation unit 602 calculates the task execution time in the node. As a result, the first calculation unit 602 may obtain an index that determines a target to be subjected to the task allocation adjustment. In addition, the first calculation unit 602 may specify a task allocation pattern that is a reference before the task allocation adjustment is performed.

A case where the first calculation unit 602 calculates the task execution time in each node when each task is allocated to the node having data to be used by the task has been described here. However, the present disclosure is not limited thereto. For example, the first calculation unit 602 may calculate the task execution time in each node when each task is allocated to a random node. Further, for example, the first calculation unit 602 may calculate the task execution time in each node when a predetermined number of tasks are allocated to a node.

The first calculation unit 602 may calculate a standard deviation of the longest task execution time and a standard deviation of the shortest task execution time among the calculated task execution times. As a result, the first calculation unit 602 may obtain an index that determines a parameter to be used by the selection unit 603, which indicates a variation in the task execution time.

The selection unit 603 specifies a plurality of node combinations that are candidates for task allocation adjustment. For example, the selection unit 603 selects one or more movement source nodes from the plurality of nodes in an order from a node with the calculated longest task execution time. The movement source node is a node desired to move a task. Next, the selection unit 603 selects one or more movement destination nodes that move the tasks of the one or more movement source nodes, from the remaining nodes. The remaining nodes are a node group obtained by excluding one or more movement source nodes from the plurality of nodes. The movement destination node is a node that may move a task. Then, the selection unit 603 specifies the selected node group as a combination. As a result, the selection unit 603 may specify a candidate for task allocation adjustment, which is a processing target of the second calculation unit 604.

For example, the selection unit 603 selects one or more movement source nodes from the plurality of nodes in an order from a node with the calculated longest task execution time. At this time, the selection unit 603 converts the task execution time of each of the one or more movement source nodes to exceed a threshold value into a first data amount. The threshold value is, for example, the longest task execution time among the task execution times in the remaining nodes. Next, the selection unit 603 selects one or more movement destination nodes so that the first data amount is smaller than a second data amount into which the task execution time of each of the one or more movement destination nodes, which is less than the threshold value, is converted. Then, the selection unit 603 specifies the selected node group as a combination. As a result, the selection unit 603 may specify a candidate for task allocation adjustment, which is a processing target of the second calculation unit 604. Further, the selection unit 603 may set the task execution time in the combination to be equal to or less than the threshold value. The task execution time in the combination is the longest task execution time that becomes a bottleneck among the task execution times in each node included in the combination.

For example, the selection unit 603 selects one or more movement source nodes in an order from a node with the calculated longest task execution time from the plurality of nodes. Next, the selection unit 603 selects one or more movement destination nodes in an order from a node with the calculated shortest task execution time from the remaining nodes. Then, the selection unit 603 specifies the selected node group as a combination. As a result, the selection unit 603 may specify a candidate for task allocation adjustment, which is a processing target of the second calculation unit 604. In addition, the selection unit 603 may minimize the number of movement destination nodes included in the combination. For this reason, the selection unit 603 may reduce the time required for adjustment.

Specifically, the selection unit 603 selects a predetermined number of movement source nodes in an order from a node having the longest task execution time. The predetermined number is an initial value of 1, for example. Next, the selection unit 603 selects one or more movement destination nodes to move tasks of a predetermined number of movement source nodes from the remaining nodes. The remaining nodes are, for example, a node group obtained by excluding a predetermined number of movement source nodes from the plurality of nodes. Then, the selection unit 603 specifies the selected node group as a combination.

Thereafter, the selection unit 603 repeats increasing the predetermined number until an adjustment target is determined. The increase width is, for example, 1. Here, every time the predetermined number increases, the selection unit 603 specifies a combination that selects a predetermined number of movement source nodes and one or more movement destination nodes from the remaining nodes in an order from the node with the longest task execution time. As a result, the selection unit 603 may increase the number of candidates for task allocation adjustment, which are the processing targets of the second calculation unit 604, one by one.

A case where the selection unit 603 sets 1 to the predetermined number of initial values and 1 to the increase width has been described here. However, the present disclosure is not limited thereto. For example, based on a result of comparison between the standard deviation of the longest task execution time and the standard deviation of the shortest task execution time, the selection unit 603 may set the predetermined number and set the increase width that increases the predetermined number.

Specifically, when the standard deviation of the longest task execution time is equal to or larger than the standard deviation of the shortest task execution time, the selection unit 603 sets 1 to the predetermined number of initial values and sets a first number to the increase width. The first number is, for example, 1. Meanwhile, specifically, when the standard deviation of the longest task execution time is smaller than the standard deviation of the shortest task execution time, the selection unit 603 sets 1 to the predetermined number of initial values and sets a second number to the increase width. The second number is larger than the first number. As a result, the selection unit 603 may specify a combination with high efficiency.

When performing the task allocation adjustment for the combination specified by the selection unit 603, the second calculation unit 604 calculates a sum of the task execution time in the combination and the time required for the adjustment. For example, each time a new combination is specified, the second calculation unit 604 calculates the sum of the task execution time in the new combination and the time required for the adjustment when performing the task allocation adjustment for the new combination. Accordingly, the second calculation unit 604 may obtain an index for determining an adjustment target.

Based on the sum calculated for each of the plurality of combinations, the determination unit 605 determines one of the plurality of combinations as an adjustment target. For example, the determination unit 605 determines a combination having the calculated smallest sum among the plurality of combinations as an adjustment target. As a result, the determination unit 605 may determine an adjustment target so that the total time required to obtain a result of the predetermined process may be reduced.

For example, each time a new sum is calculated, when there is a sum that satisfies a predetermined condition among the calculated sums, the determination unit 605 determines a combination for which a sum satisfying the predetermined condition is calculated, as an adjustment target. Specifically, when the new sum is larger than the sum calculated immediately before, the determination unit 605 determines a combination corresponding to the sum calculated immediately before, as an adjustment target. As a result, the determination unit 605 may determine an adjustment target so that the total time required to obtain a result of the predetermined process may be reduced.

The output unit 606 outputs the target determined by the determination unit 605 to a functional unit (not illustrated) that actually performs the task allocation adjustment. As a result, the output unit 606 may perform the task allocation adjustment, thereby reducing the total time required to obtain a result of the predetermined process. According to a result of the task allocation adjustment, the output unit 606 outputs a task execution request to each of the plurality of nodes. As a result, the output unit 606 may execute the task.

The output unit 606 may output a processing result of any functional unit. The output format is, for example, display on a display, print output to a printer, transmission to an external device via the network I/F 403, storage in a storage area such as the memory 402 or the recording medium 405, etc. For example, the output unit 606 outputs an adjustment target determined by the determination unit 605. As a result, the output unit 606 may notify a user of the processing result of any functional unit.

### Operation Example 1 of Information Processing Apparatus 100

Next, operation example 1 of the information processing apparatus 100 in the distributed processing system 200 illustrated in FIG. 2 will be described as an example with reference to FIGS. 7 to 11.

FIGS. 7 to 11 are explanatory views illustrating operation example 1 of the information processing apparatus 100. FIG. 7 illustrates, for example, the nature of task placement determination. The task placement determination is, for example, an operation of searching for all combinations of placement patterns in which tasks are placed in the plurality of edge servers 201 as the task placement determination targets so as to minimize the task execution times in the plurality of edge servers 201 as the task placement determination targets. The task execution time is a sum of the network transfer time and the task processing time.

Here, the network transfer time is the time required to transfer data to be used by a task to a task placement destination, which corresponds to the data amount/bandwidth to be transferred. The task placement determination minimizes the bottleneck of the network transfer time in the entire plurality of edge servers 201 as a task placement determination target. The task processing time is calculated based on the number of tasks and the amount of computation resources. The task placement determination minimizes the bottleneck of the task processing time in the entire plurality of edge servers 201 as the task placement determination target.

In addition, a placement pattern in which tasks are placed for the plurality of edge servers 201 as the task placement determination target corresponds to a transfer pattern of which edge server 201 transfers data to be used by a task. The transfer pattern is an order of the square of the number of edge servers 201 as the task placement determination target, which corresponds to a combination of upload and download.

For this reason, unless the number of edge servers 201 as the task placement determination target is reduced, the number of placement patterns using all combinations is enormous, which results in increase in the time required for the task placement determination. In the following description, the time required for the task placement determination may be referred to as “task placement determination time”. For example, a relationship between the number X of edge servers 201 as the task placement determination target and the task placement determination time f(X) may be represented by a characteristic curve 711 of a graph 710.

Meanwhile, when the number of edge servers 201 as the task placement determination target is reduced too much, the bottleneck of the task execution time increases. For example, even when there is a free computation resource of an edge server 201 that is not the task allocation determination target, the bottleneck of the task execution time tends to increase because the free computation resource is not used to level the task execution time. In addition, for example, the task execution time in the edge server 201 that is not the task placement determination target may be a bottleneck. For example, a relationship between the number X of edge servers 201 as the task placement determination target and the task execution time g(X) may be represented by a characteristic curve 721 of a graph 720.

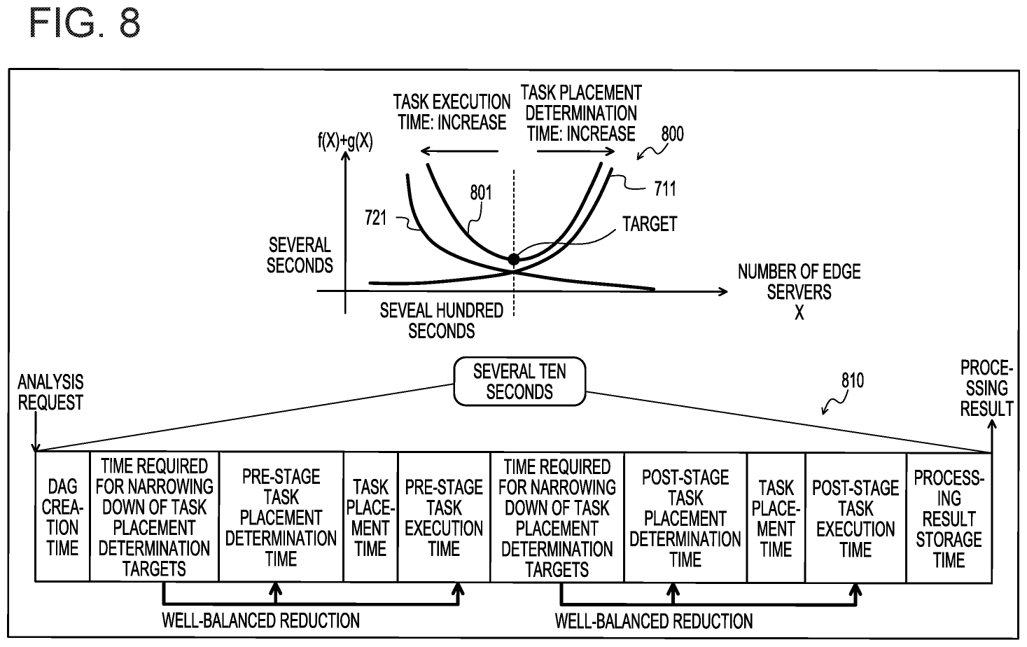

In this manner, there is a trade-off relationship between the reduction in task placement determination time f(X) and the reduction in task execution time g(X). Therefore, in an order to reduce the time required to obtain a result of the predetermined process, it is desirable to reduce the task placement determination time f(X) and the task execution time g(X) in a well-balanced manner. In the following description, the time required to obtain a result of the predetermined process may be referred to as “total required time”. Now, the description will be given with FIG. 8.

As illustrated in FIG. 8, considering the trade-off relationship, the information processing apparatus 100 reduces the task placement determination time f(X) and the task execution time g(X) in a well-balanced manner by narrowing down task allocation determination targets prior to the task placement determination. The relationship between the number X of edge servers 201 as the task placement determination target and the sum f(X)+g(X) may be represented by a characteristic curve 801 of a graph 800.

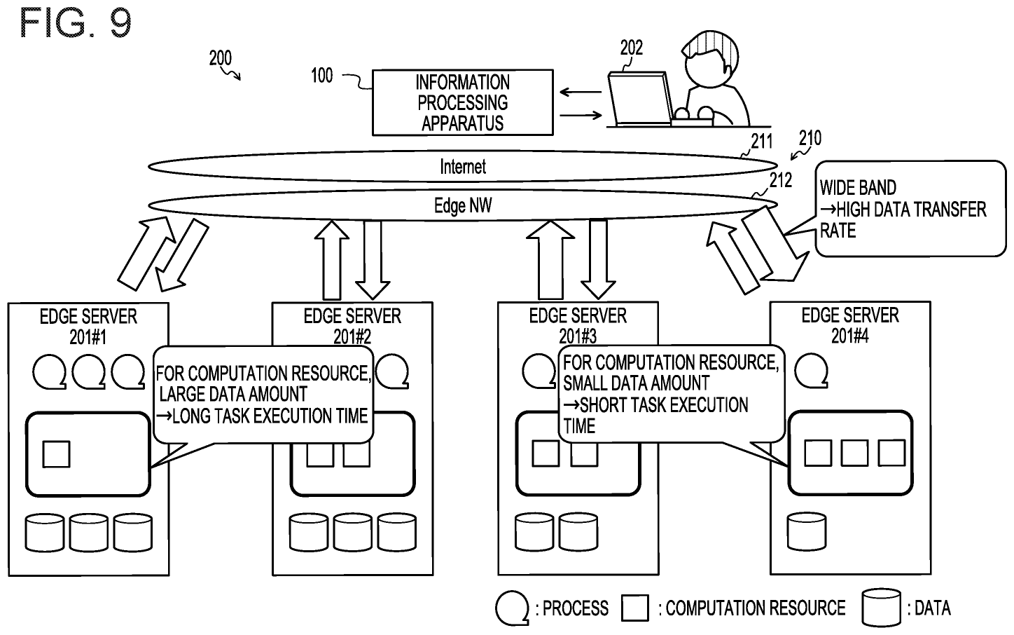

In the example of use of the distributed processing system 200 illustrated in FIG. 3, the information processing apparatus 100 narrows down the task placement determination targets prior to pre-stage task placement determination for a plurality of pre-stage tasks. In addition, the information processing apparatus 100 narrows down the task placement determination targets prior to post-stage task placement determination for a plurality of post-stage tasks. The contents of the narrowing down of the task placement determination targets will be described below with reference to FIG. 9.

As illustrated in FIG. 9, the information processing apparatus 100 allocates each of a plurality of tasks to an edge server 201 having data to be used by the task. Here, when the amount of data is large relative to the amount of computation resource of the edge server 201, the number of tasks large relative to the amount of computation resource of the edge server 201 is allocated to the edge server 201, which may result in increase in the task execution time. For example, the edge server 201#1 executes three tasks with a single computation resource, and the task execution time increases.

In the meantime, when the amount of data is small relative to the amount of computation resource of the edge server 201, the number of tasks small relative to the amount of computation resource of the edge server 201 is allocated to the edge server 201, which may result in decrease in the task execution time. For example, the edge server 201#4 may execute a single task with three computation resources, and the task execution time decreases. Further, an edge server 201 having a wider band has a higher data transfer rate and tends to move data relatively easily.

Here, the information processing apparatus 100 narrows down the task placement determination targets. For example, the information processing apparatus 100 narrows down the task placement determination targets to an edge server 201 desired to move a task and an edge server 201 that has the affordability to move a task. An edge server 201 preferably moves a task to another edge server 201 for load distribution as the task execution time increases. The affordability to move a task means that the task execution time in the edge server 201 may be suppressed to a certain value or less even when the task is moved.

Specifically, the information processing apparatus 100 increases the number of edge servers 201 as movement sources desired to move a task, one by one in an order from an edge server 201 having the longest task execution time. Each time the information processing apparatus 100 increases the number of edge servers 201 as the movement sources, the information processing apparatus 100 selects an edge server 201 as a movement destination in an order from an edge server 201 having the shortest task execution time, and calculates the task placement determination time f(X) and the task execution time g(X). The information processing apparatus 100 calculates the sum f(X)+g(X) of the task placement determination time f(X) and the task execution time g(X).

Then, the information processing apparatus 100 specifies a combination of edge servers 201 that minimizes the sum f(X)+g(X) of the task placement determination time f(X) and the task execution time g(X), and determines the specified combination as a task placement determination target. As a result, the information processing apparatus 100 may reduce the total required time when a plurality of tasks are executed in a distributed manner by a plurality of edge servers 201.

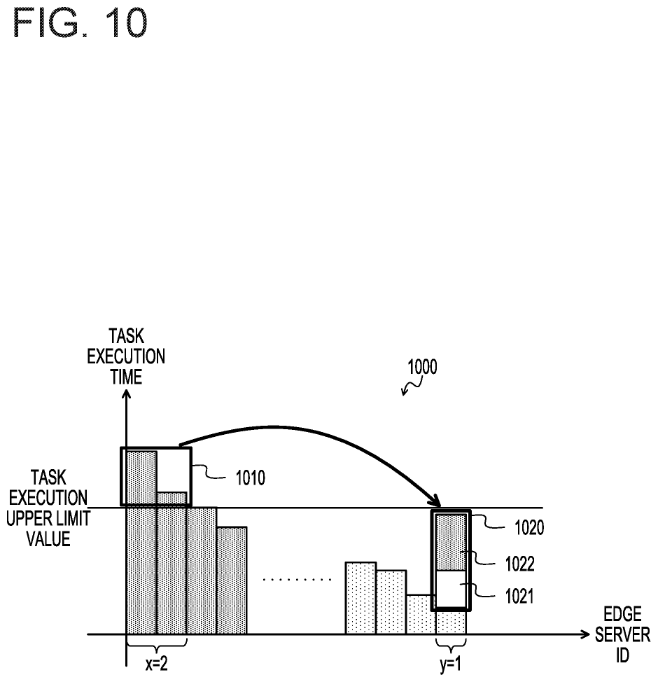

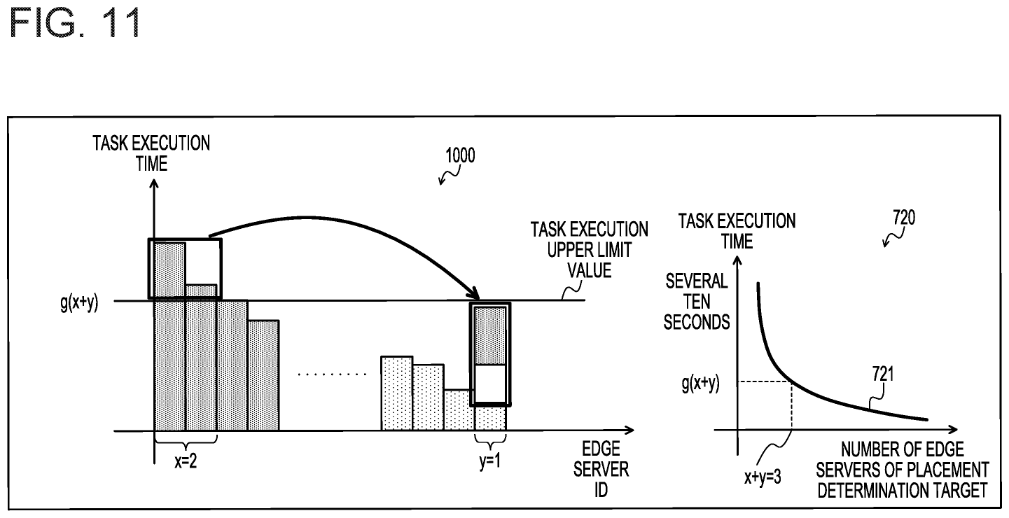

In the related art, for example, when there are several hundred edge servers 201, it may take several minutes from receiving an analysis request query to outputting an analysis processing result. In contrast, for example, even when there are several hundred edge servers 201, the information processing apparatus 100 may suppress a period 810 from receiving an analysis request query to outputting an analysis processing result, including the narrowing down of the task placement determination targets, to several tens of seconds. The contents of the narrowing down of the task placement determination targets will be described below with reference to FIGS. 10 and 11.

As illustrated in FIG. 10, the information processing apparatus 100 prepares a variable x and increments the variable x by one. Each time the variable x is incremented by one, the information processing apparatus 100 selects x movement source edge servers 201, and selects y movement destination edge servers 201 to which tasks are moved from the x movement source edge servers 201.

Each time the information processing apparatus 100 selects a group of edge servers 201 including x movement source edge servers 201 and y movement destination edge servers 201, the information processing apparatus 100 sets the group of edge servers 201 as a task placement determination target candidate. The information processing apparatus 100 calculates the sum s(x)=f(x+y)+g(x+y) of the task placement determination time f(x+y) and the task execution time g(x+y) for the task placement determination target candidate. Here, x+y corresponds to the above-mentioned X.

Then, each time the information processing apparatus 100 calculates the sum s(x), the information processing apparatus 100 determines whether the sum s(x) calculated this time is larger than the sum s(x−1) calculated last time. Since the characteristic curve 801 of the sum s(x) is concave, when the sum s(x) calculated this time is larger than the sum s(x−1) calculated last time, the information processing apparatus 100 determines that the sum s(x−1) calculated last time is the minimum value. For this reason, the information processing apparatus 100 determines that the previous task placement determination candidate is the task placement determination target.

Here, taking a case of x=2 as an example, a specific example in which the information processing apparatus 100 selects y movement destination edge servers 201 will be described with reference to a graph 1000 illustrating an example of task execution time for each edge server 201.

First, the information processing apparatus 100 converts an excess 1010 from the task execution upper limit value of the task execution time in each of x(=2) movement source edge servers 201 into a data amount. The task execution upper limit value is an upper limit value common to task execution times in edge servers 201 that are assumed as task placement determination targets. When the task execution time of a single task and the amount of data to be used by a single task are known, the information processing apparatus 100 may specify the amount of data to be handled per unit time. Therefore, considering the amount of computation resource, the excess 1010 may be converted into a data amount.

Even when the converted data amount is downloaded from each of x(=2) movement source edge servers 201 and a task that handles the converted data amount is executed, the information processing apparatus 100 selects y edge servers 201 whose task execution time does not exceed the task execution upper limit value, as movement destinations. In other words, even when the task execution time increases over the sum 1020 of the time 1021 required for downloading the converted data amount and the time 1022 required for executing the task that handles the converted data amount, the information processing apparatus 100 selects a movement destination that does not exceed the task execution upper limit value. The time 1022 required for executing the task that handles the converted data amount is calculated in consideration of, for example, the amount of computation resource. In the example of FIG. 10, the information processing apparatus 100 selects edge servers 201 up to y=1 as movement destinations in an order from an edge server 201 having the shortest task execution time. Here, the task execution upper limit value will be described in detail with reference to FIG. 11.

As illustrated in FIG. 11, when x=2, the task execution time in the edge servers 201 from the edge server 201 having the longest task execution time to the x=2nd edge server 201 is treated as a bottleneck as a whole and these edge servers 201 are selected as movement sources.

Meanwhile, even when all the tasks of the x=2 movement source edge servers are moved, the task execution time in the edge servers 201 from the edge server 201 having the longest task execution time to the x+1=3rd edge server 201 is not reduced. For this reason, even when all the tasks of the x=2 movement source edge servers 201 are moved, the task execution time in the edge servers 201 from the edge server 201 having the longest task execution time to the x+1=3rd edge server 201 is a bottleneck as a whole.

Therefore, even when the task execution time in the x=2 movement edge servers 201 is set to be shorter than the task execution time in the x+1=3rd edge server 201, the overall bottleneck may not be reduced. For this reason, for example, the information processing apparatus 100 sets the task execution time in the x+1=3rd edge server 201 as the task execution upper limit value.

Thus, when x+y=3 edge servers 201 are task placement determination target candidates, the task execution time g(x+y) in the entire task placement determination targets matches the task execution upper limit value. Therefore, when calculating the sum s(x) of the task placement determination time f(x+y) and the task execution time g(x+y), the information processing apparatus 100 may use the task execution time g(x+y) in the entire task placement determination targets as the task execution upper limit value.

[Entire Processing Procedure in Operation Example 1]

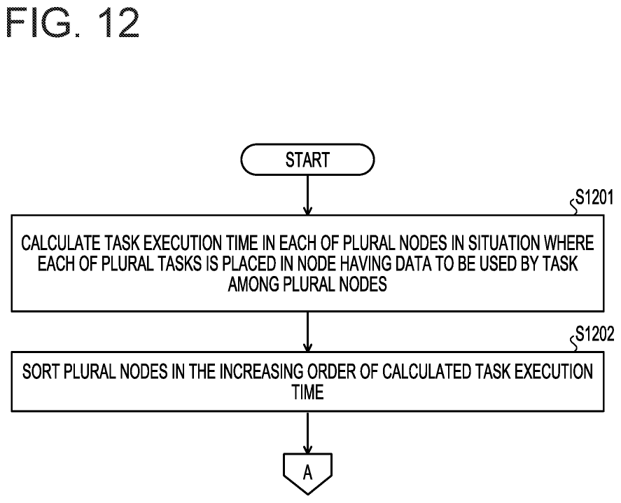

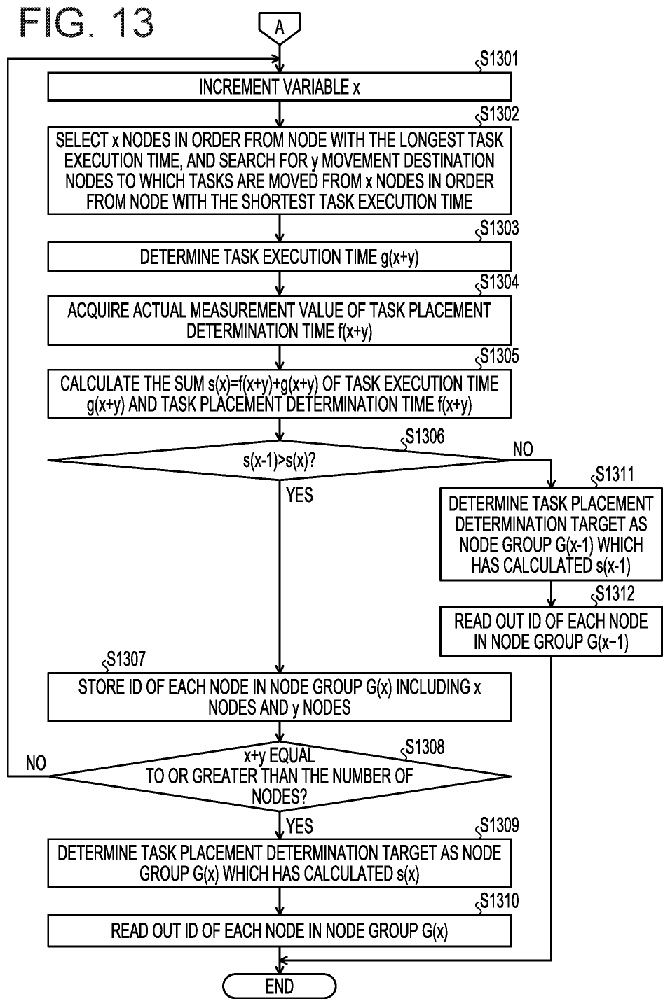

Next, an example of the entire processing procedure executed by the information processing apparatus 100 in operation example 1 will be described with reference to FIGS. 12 and 13. The entire processing is implemented by, for example, the CPU 401, a storage area such as the memory 402 or the recording medium 405, and the network I/F 403, which are illustrated in FIG. 4.

FIGS. 12 and 13 are flowcharts illustrating an example of the entire processing procedure in operation example 1. In FIG. 12, in a situation where each of a plurality of tasks is placed in a node having data used by the task among a plurality of nodes, the information processing apparatus 100 calculates the task execution time in each of the plurality of nodes (operation S1201).

Next, the information processing apparatus 100 sorts the plurality of nodes in the increasing order of the calculated task execution time (operation S1202). Then, the information processing apparatus 100 proceeds to the process of operation S1301 in FIG. 13. Here, the description shifts to the description of FIG. 13.

In FIG. 13, the information processing apparatus 100 increments a variable x (operation S1301). Next, the information processing apparatus 100 selects x nodes in an order from a node with the longest task execution time, and searches for y movement destination nodes to which tasks are moved from the x nodes in an order from a node with the shortest task execution time (operation S1302). Then, the information processing apparatus 100 determines the task execution time g(x+y) (operation S1303).

Next, the information processing apparatus 100 acquires an actual measurement value of the task placement determination time f(x+y) (operation S1304). Then, the information processing apparatus 100 calculates the sum s(x)=f (x+y)+g(x+y) of the task execution time g(x+y) and the task placement determination time f(x+y) (operation S1305).

Next, the information processing apparatus 100 determines whether s(x−1) is greater than s(x) (operation S1306). When it is determined that s(x−1) is not greater than s(x) (“No” in operation S1306), the information processing apparatus 100 proceeds to the process of operation S1311. Meanwhile, when it is determined that s(x−1) is greater than s(x) (“Yes” in operation S1306), the information processing apparatus 100 proceeds to the process of operation S1307.

In operation S1307, the information processing apparatus 100 stores the ID of each node in a node group G(x) including x nodes and y nodes (operation S1307). Next, the information processing apparatus 100 determines whether x+y is equal to or greater than the number of nodes (operation S1308). When it is determined that x+y is not equal to or greater than the number of nodes (“No” in operation S1308), the information processing apparatus 100 returns to the process of operation S1301. Meanwhile, when it is determined that x+y is equal to or greater than the number of nodes (“Yes” in operation S1308), the information processing apparatus 100 proceeds to the process of operation S1309.

In operation S1309, the information processing apparatus 100 determines a task placement determination target as a node group G(x) which has calculated s(x) (operation S1309). Next, the information processing apparatus 100 reads out the ID of each node in the node group G(x) (operation S1310). Then, the information processing apparatus 100 ends the entire process.

In operation S1311, the information processing apparatus 100 determines a task placement determination target as a node group G(x−1) which has calculated s(x−1) (operation S1311). Next, the information processing apparatus 100 reads out the ID of each node in the node group G(x−1) (operation S1312). Then, the information processing apparatus 100 ends the entire process.

Here, for the purpose of simplification of explanation, a case where the information processing apparatus 100 has successfully searched for y nodes in operation S1302 has been described. However, the present disclosure is not limited thereto. For example, in operation S1302, a case where the y nodes have been unsuccessfully searched may be considered. In this case, the information processing apparatus 100 may determine the task placement determination target as the node group G(x−1) which has calculated s(x−1).

### Operation Example 2 of Information Processing Apparatus 100

Next, operation example 2 of the information processing apparatus 100 in the distributed processing system 200 illustrated in FIG. 2 will be described as an example with reference to FIGS. 14 to 18.

FIGS. 14 to 18 are explanatory views illustrating operation example 2 of the information processing apparatus 100. As illustrated in FIG. 14, operation example 2 is an example in which the information processing apparatus 100 reduces the total required time by further reducing the time required for the narrowing down of the task placement determination target.

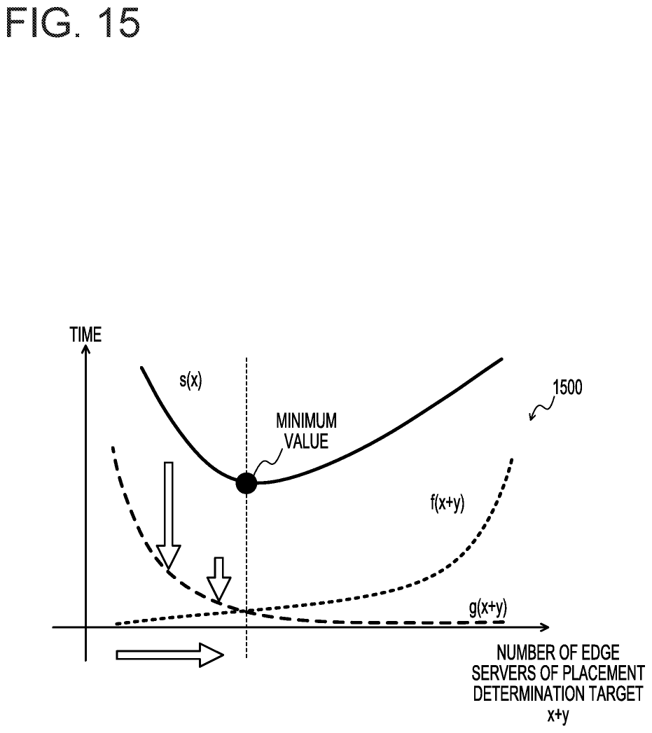

For example, the amount of decrease in the task execution time g(x+y) has a disposition of variation depending on the degree of bias in the amount of data and the amount of computation resource between edge servers 201. For this reason, the information processing apparatus 100 estimates whether a task placement determination target having the minimum of the sum s(x+y) may be found relatively early based on the disposition, and reduces the time required for narrowing down of task placement determination targets based on the estimation. The term “early” used herein means that x+y is relatively small. A situation where a task placement determination target having the minimum of the sum s(x+y) may be found relatively early will be described below with reference to FIG. 15.

In the example of FIG. 15, as illustrated in a graph 1500, depending on the degree of bias in the amount of data and the amount of computation resource between edge servers 201, the amount of decrease in g(x+y) accompanying the increase in the number x+y of edge servers 201 as task placement determination targets is large. For this reason, as illustrated in the graph 1500, the number x+y of edge servers 201 as the task placement determination targets having the minimum of the sum s(x+y) tends to be relatively small. Therefore, in the situation of FIG. 15, the information processing apparatus 100 determines that a task placement determination target having the minimum of the sum s(x+y) may be found relatively early.

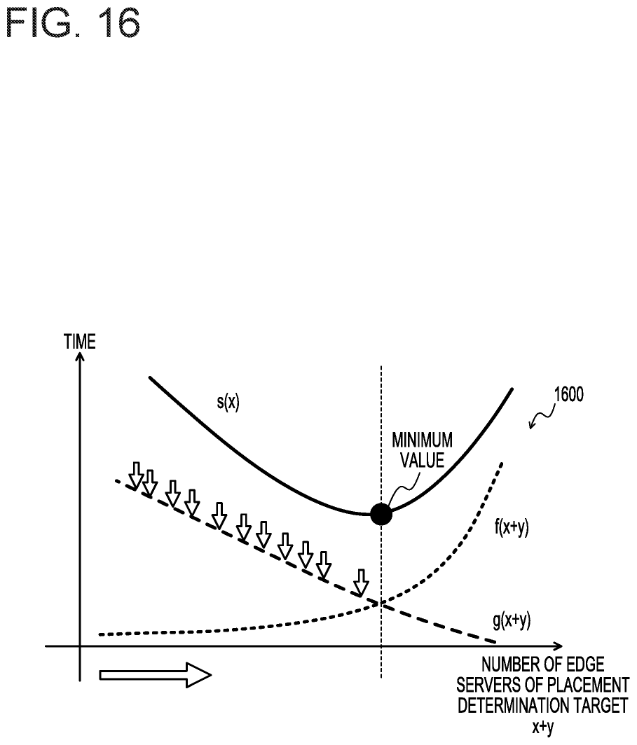

For this reason, even when searching for a task placement determination target having the minimum of the sum s(x) while varying the variable x relatively small, the information processing apparatus 100 determines that the task placement determination target having the minimum of the sum s(x) may be specified early, and sets the variable x to a first number. The first number is relatively small, for example, 1. Then, the information processing apparatus 100 searches for a task placement determination target having the minimum of the sum s(x) while varying the variable x by the first number. A situation where a task placement determination target having the minimum of the sum s(x+y) may not be found relatively early will be described below with reference to FIG. 16.

In the example of FIG. 16, as illustrated in a graph 1600, depending on the degree of bias in the amount of data and the amount of computation resource between edge servers 201, the amount of decrease in g(x+y) accompanying the increase in the number x+y of edge servers 201 as task placement determination targets is small. For this reason, as illustrated in the graph 1600, the number x+y of edge servers 201 as the task placement determination targets having the minimum of the sum s(x+y) tends to be relatively large. Therefore, in the situation of FIG. 16, the information processing apparatus 100 determines that a task placement determination target having the minimum of the sum s(x) may not be found relatively early.

For this reason, unless the variable x is varied relatively large, the information processing apparatus 100 determines that the time required to specify the task placement determination target having the minimum of the sum s(x) is increased, and sets the variable x to a second number. The second number is greater than the first number. The second number may be variable as it increases. Then, the information processing apparatus 100 searches for a task placement determination target having the minimum of the sum s(x) while varying the variable x by the second number.

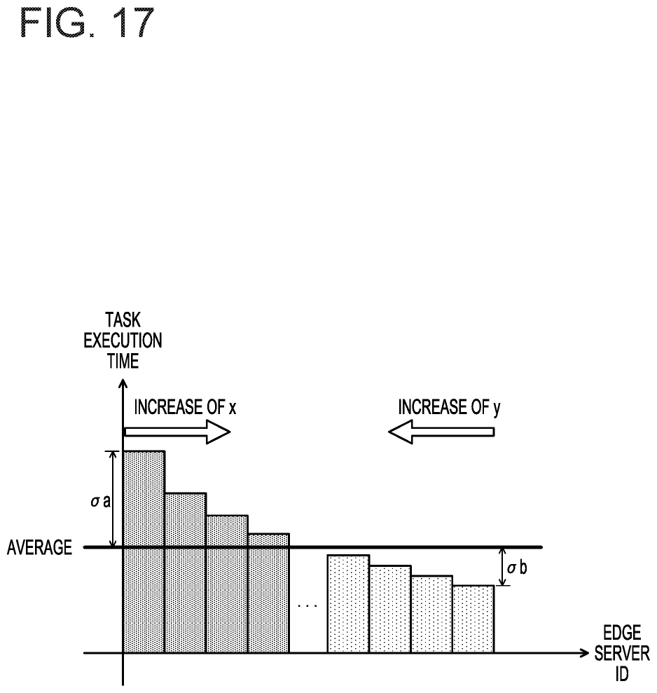

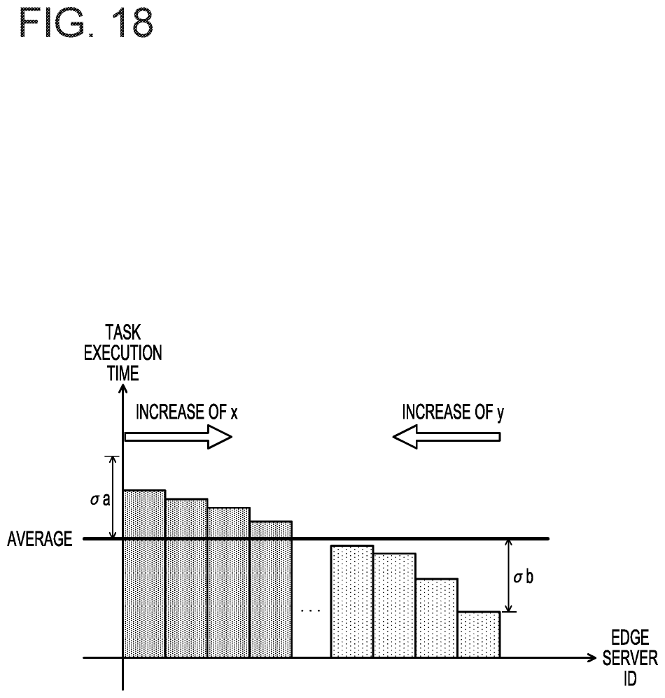

A specific example in which the information processing apparatus 100 determines whether a task placement determination target having the minimum of the sum s(x) may be found relatively early, and determines a task placement determination target will be described below with reference to FIGS. 17 and 18.

FIG. 17 illustrates a specific example where the information processing apparatus 100 determines that a task placement determination target having the minimum of the sum s(x) may be found relatively early in a situation corresponding to FIG. 15. As illustrated in FIG. 17, the information processing apparatus 100 calculates the standard deviation σa of the longest task execution time and calculates the standard deviation σb of the shortest task execution time.

Here, when σa>σb, the information processing apparatus 100 determines that the situation corresponds to FIG. 15, and searches for a task placement determination target having the minimum of the sum s(x) while increasing the variable x one by one. As a result, the information processing apparatus 100 may reduce the total required time while considering the time required for the narrowing down of task placement determination targets.

FIG. 18 illustrates a specific example where the information processing apparatus 100 determines that a task placement determination target having the minimum of the sum s(x) may not be found relatively early in a situation corresponding to FIG. 16. As illustrated in FIG. 18, the information processing apparatus 100 calculates the standard deviation σa of the longest task execution time and calculates the standard deviation σb of the shortest task execution time.

Here, when σa≤σb, the information processing apparatus 100 determines that the situation corresponds to FIG. 16, and searches for a task placement determination target having the minimum of the sum s(x) while increasing the variable x exponentially. As a result, the information processing apparatus 100 may reduce the time required for the narrowing down of task placement determination targets, thereby reducing the total required time.

Descriptions have been made on a case where the information processing apparatus 100 determines the situation by using the standard deviation σa of the longest task execution time and the standard deviation σb of the shortest task execution time. However, the present disclosure is not limited thereto. For example, the information processing apparatus 100 may set the next variable x based on a difference between the current sum (x) and the previous sum s(x−1).

[Entire Processing Procedure in Operation Example 2]

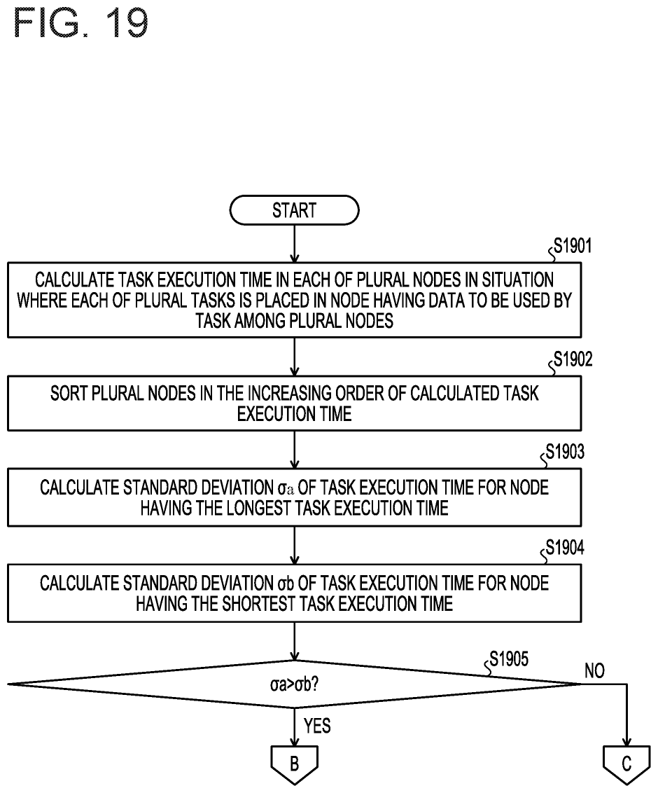

Next, an example of the entire processing procedure executed by the information processing apparatus 100 in operation example 2 will be described with reference to FIGS. 19 to 21. The entire processing is implemented by, for example, the CPU 401, a storage area such as the memory 402 or the recording medium 405, and the network I/F 403, which are illustrated in FIG. 4.

FIGS. 19 to 21 are flowcharts illustrating an example of the entire processing procedure in operation example 2. In FIG. 19, in a situation where each of a plurality of tasks is placed in a node having data used by the task among a plurality of nodes, the information processing apparatus 100 calculates the task execution time in each of the plurality of nodes (operation S1901).

Next, the information processing apparatus 100 sorts the plurality of nodes in the increasing order of the calculated task execution time (operation S1902). Then, the information processing apparatus 100 calculates the standard deviation σa of the task execution time for a node having the longest task execution time (operation S1903).

Next, the information processing apparatus 100 calculates the standard deviation σb of the task execution time for a node having the shortest task execution time (operation S1904). Then, the information processing apparatus 100 determines whether σa is greater than σb (operation S1905).

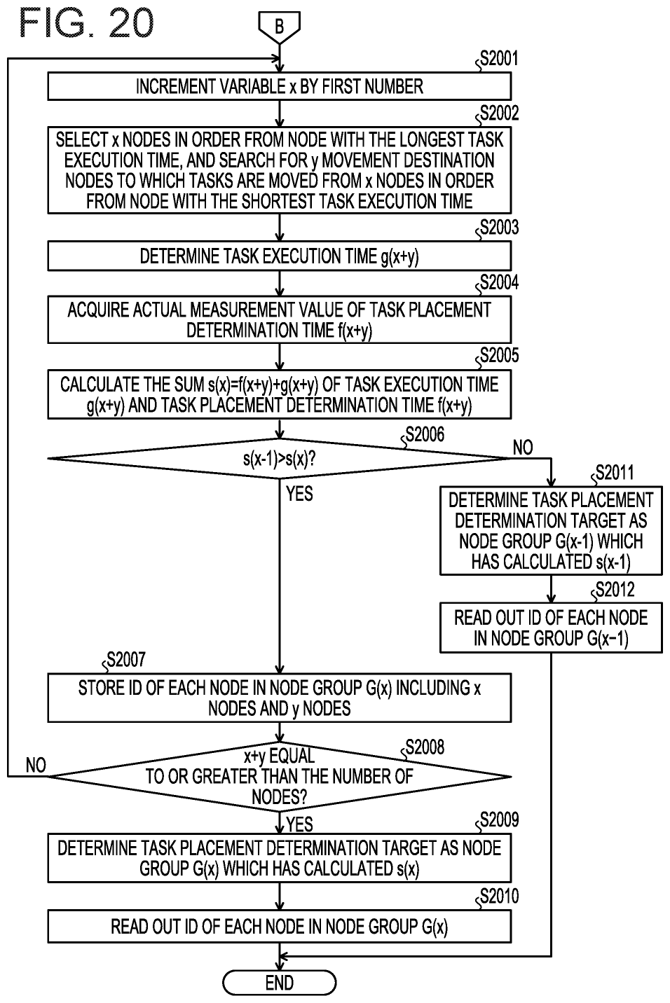

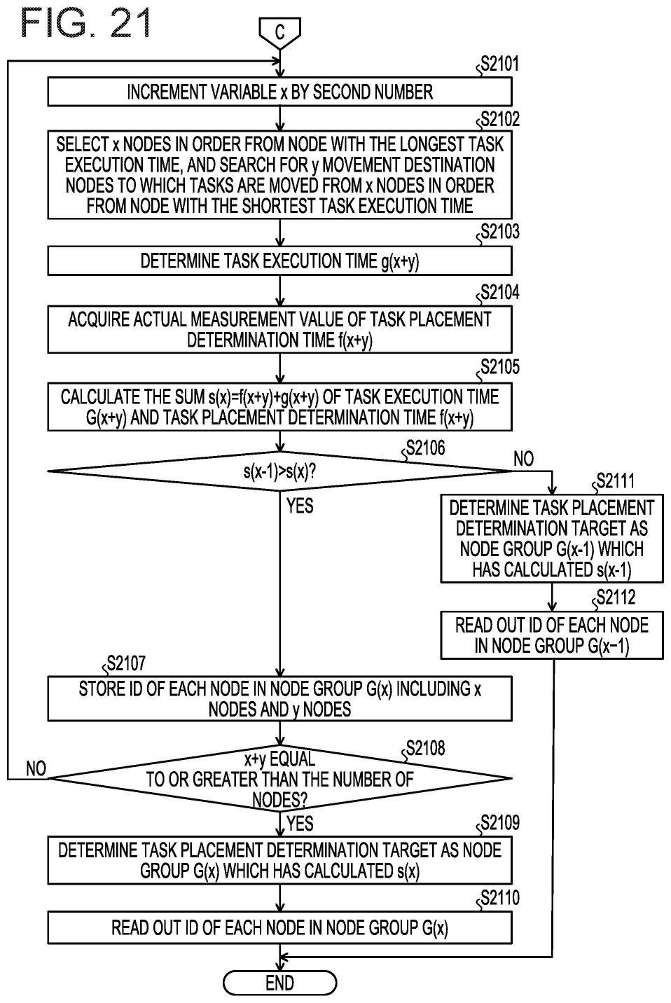

Here, when it is determined that σa is greater than σb (“Yes” in operation S1905), the information processing apparatus 100 proceeds to the process of operation S2001 in FIG. 20. Meanwhile, when it is determined that σa is not greater than σb (“No” in operation S1905), the information processing apparatus 100 proceeds to the process of operation S2101 in FIG. 21. The description will be given with FIG. 20.

In FIG. 20, the information processing apparatus 100 increments a variable x by a first number (operation S2001). Next, the information processing apparatus 100 selects x nodes in an order from a node with the longest task execution time, and searches for y movement destination nodes to which tasks are moved from the x nodes in an order from a node with the shortest task execution time (operation S2002). Then, the information processing apparatus 100 determines the task execution time g(x+y) (operation S2003).

Next, the information processing apparatus 100 acquires an actual measurement value of the task placement determination time f(x+y) (operation S2004). Then, the information processing apparatus 100 calculates the sum s(x)=f (x+y)+g(x+y) of the task execution time g(x+y) and the task placement determination time f(x+y) (operation S2005).

Next, the information processing apparatus 100 determines whether s(x−1) is greater than s(x) (operation S2006). When it is determined that s(x−1) is not greater than s(x) (“No” in operation S2006), the information processing apparatus 100 proceeds to the process of operation S2011. Meanwhile, when it is determined that s(x−1) is greater than s(x) (“Yes” in operation S2006), the information processing apparatus 100 proceeds to the process of operation S2007.

In operation S2007, the information processing apparatus 100 stores the ID of each node in a node group G(x) including x nodes and y nodes (operation S2007). Next, the information processing apparatus 100 determines whether x+y is equal to or greater than the number of nodes (operation S2008). When it is determined that x+y is not equal to or greater than the number of nodes (“No” in operation S2008), the information processing apparatus 100 returns to the process of operation S2001. Meanwhile, when it is determined that x+y is equal to or greater than the number of nodes (“Yes” in operation S2008), the information processing apparatus 100 proceeds to the process of operation S2009.

In operation S2009, the information processing apparatus 100 determines a task placement determination target as a node group G(x) which has calculated s(x) (operation S2009). Next, the information processing apparatus 100 reads out the ID of each node in the node group G(x) (operation S2010). Then, the information processing apparatus 100 ends the entire process.

In operation S2011, the information processing apparatus 100 determines a task placement determination target as a node group G(x−1) which has calculated s(x−1) (operation S2011). Next, the information processing apparatus 100 reads out the ID of each node in the node group G(x−1) (operation S2012). Then, the information processing apparatus 100 ends the entire process.

In FIG. 21, the information processing apparatus 100 increments the variable x by a second number greater than the first number (operation S2101). Next, the information processing apparatus 100 selects x nodes in an order from a node with the longest task execution time, and searches for y movement destination nodes to which tasks are moved from the x nodes in an order from a node with the shortest task execution time (operation S2102). Then, the information processing apparatus 100 determines the task execution time g(x+y) (operation S2103).

Next, the information processing apparatus 100 acquires an actual measurement value of the task placement determination time f(x+y) (operation S2104). Then, the information processing apparatus 100 calculates the sum s(x)=f (x+y)+g(x+y) of the task execution time g(x+y) and the task placement determination time f(x+y) (operation S2105).

Next, the information processing apparatus 100 determines whether s(x−1) is greater than s(x) (operation S2106). When it is determined that s(x−1) is not greater than s(x) (“No” in operation S2106), the information processing apparatus 100 proceeds to the process of operation S2111. Meanwhile, when it is determined that s(x−1) is greater than s(x) (“Yes” in operation S2106), the information processing apparatus 100 proceeds to the process of operation S2107.

In operation S2107, the information processing apparatus 100 stores the ID of each node in a node group G(x) including x nodes and y nodes (operation S2107). Next, the information processing apparatus 100 determines whether x+y is equal to or greater than the number of nodes (operation S2108). When it is determined that x+y is not equal to or greater than the number of nodes (“No” in operation S2108), the information processing apparatus 100 returns to the process of operation S2101. Meanwhile, when it is determined that x+y is equal to or greater than the number of nodes (“Yes” in operation S2108), the information processing apparatus 100 proceeds to the process of operation S2109.

In operation S2109, the information processing apparatus 100 determines a task placement determination target as a node group G(x) which has calculated s(x) (operation S2109). Next, the information processing apparatus 100 reads out the ID of each node in the node group G(x) (operation S2110). Then, the information processing apparatus 100 ends the entire process.

In operation S2111, the information processing apparatus 100 determines a task placement determination target as a node group G(x−1) which has calculated s(x−1) (operation S2111). Next, the information processing apparatus 100 reads out the ID of each node in the node group G(x−1) (operation S2112). Then, the information processing apparatus 100 ends the entire process.

Here, for the purpose of simplification of explanation, a case where the information processing apparatus 100 has successfully searched for y nodes in operation S2002 has been described. However, the present disclosure is not limited thereto. For example, in operation S2002, a case where the y nodes have been unsuccessfully searched may be considered. In this case, the information processing apparatus 100 may determine the task placement determination target as the node group G(x−1) which has calculated s(x−1).

Here, for the purpose of simplification of explanation, a case where the information processing apparatus 100 has successfully searched for y nodes in operation S2102 has been described. However, the present disclosure is not limited thereto. For example, in operation S2102, a case where the y nodes have been unsuccessfully searched may be considered. In this case, the information processing apparatus 100 may determine the task placement determination target as the node group G(x−1) which has calculated s(x−1).

As described above, according to the information processing apparatus 100, when each of a plurality of processes forming a predetermined process is allocated to one of a plurality of nodes, it is possible to calculate the process execution time in each of the plurality of nodes. According to the information processing apparatus 100, it is possible to specify a plurality of combinations that select one or more movement source nodes and one or more movement destination nodes to which the processes of the one or more movement source nodes are moved among the remaining nodes in an order from a node with the longest process execution time. According to the information processing apparatus 100, when the process allocation adjustment is performed for each of the plurality of combinations, it is possible to calculate the sum of the process execution time in the combination and the time required for the adjustment. According to the information processing apparatus 100, it is possible to determine any one of the plurality of combinations as an adjustment target based on the sum calculated for each combination. Thus, the information processing apparatus 100 may reduce the time required to obtain a result of the predetermined process when the plurality of processes forming the predetermined process are executed in a distributed manner by the plurality of nodes.

According to the information processing apparatus 100, it is possible to convert the amount of process execution time of each of one or more movement source nodes to exceed a threshold value into the first data amount. According to the information processing apparatus 100, it is possible to select one or more movement destination nodes so that the first data amount is smaller than the second data amount into which the task execution time of each of the one or more movement destination nodes, which is less than the threshold value, is converted. As a result, when a task is moved between nodes having different amounts of computation resources or the like via the data amount, the information processing apparatus 100 may consider how much the process execution time is increased at the movement destination. Then, the information processing apparatus 100 may suppress the process execution time to be equal to or less than the threshold value for both the movement source nodes and the movement destination nodes. For this reason, the information processing apparatus 100 may suppress the time required for the entire predetermined process to be equal to or less than the threshold value.

According to the information processing apparatus 100, it is possible to specify a combination that selects one or more movement source nodes in an order from the node with the longest process execution time and one or more movement destination nodes in an order from the node with the smallest process execution time. As a result, the information processing apparatus 100 may reduce the number of nodes included in the combination. For this reason, the information processing apparatus 100 may reduce the time required for the adjustment.

According to the information processing apparatus 100, it is possible to increase the predetermined number until an adjustment target is determined. According to the information processing apparatus 100, each time the predetermined number is increased, it is possible to specify a combination that selects a predetermined number of nodes and one or more movement destination nodes among the remaining nodes in an order from the node having the longest process execution time. According to the information processing apparatus 100, when there is a sum that satisfies a predetermined condition among the calculated sums, it is possible to determine a combination that has calculated the sum satisfying the predetermined condition, as an adjustment target. As a result, the information processing apparatus 100 may determine an appropriate combination as an adjustment target without calculating sums for all possible combinations. Further, the information processing apparatus 100 does not have to calculate the sums for all possible combinations, thereby reducing the processing load.

According to the information processing apparatus 100, it is possible to calculate the standard deviation of the longest process execution time and the standard deviation of the shortest process execution time among the calculated process execution times. According to the information processing apparatus 100, it is possible to set a predetermined number based on a result of comparison between the calculated standard deviation of the longest process execution time and the calculated standard deviation of the shortest process execution time, and set the amount of increase in the predetermined number. As a result, the information processing apparatus 100 may determine whether the sum satisfying the predetermined condition may be calculated early. The term “early” used herein indicates a point of time when the predetermined number is relatively small. Then, the information processing apparatus 100 may set the amount of increase in the predetermined number according to a situation, and may reduce the time required for the adjustment.

According to the information processing apparatus 100, when each of the plurality of processes is allocated to a node having data to be used by the process among the plurality of nodes, it is possible to calculate the process execution time in each of the plurality of nodes. As a result, the information processing apparatus 100 may specify a process allocation pattern, which is a reference before the process allocation adjustment is performed, and calculate the process execution time for each node.

According to the information processing apparatus 100, it is possible to calculate the process execution time in each node based on the amount of computation resource possessed by each node. As a result, the information processing apparatus 100 may calculate the process execution time in each node even when different nodes have different amounts of computation resources.

The distributed processing method described in the present embodiment may be implemented by executing a prepared program on a computer such as a personal computer or a workstation. The distributed processing program described in the present embodiment is recorded on a computer-readable recording medium such as a hard disk, a flexible disk, a CD-ROM, an MO, a DVD, or the like, and is executed by being read from the recording medium by the computer. Further, the distributed processing program described in the present embodiment may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
when each of a plurality of processes is allocated to any one of a plurality of nodes, calculate a process execution time, for each of the plurality of nodes, in which one or more processes of the plurality of processes to be allocated to the node are performed in the node;
select a first node group that includes one or more nodes of the plurality of nodes in an order from the node with a calculated longest process execution time among the plurality of nodes;
select a second node group that includes one or more nodes of the plurality of nodes to which processes of the first node group are allocated among remaining nodes excluding the first node group from the plurality of nodes;
calculate a sum of the process execution time in each of a plurality of combinations of the node of the first node group and the node of the second node group and an adjustment time that each of the plurality of processes is allocated to any one of the plurality of nodes; and
determine any one of the plurality of combinations as an adjustment target, based on the sum calculated for each of the plurality of combinations.

2. The information processing apparatus according to claim 1,
wherein the processor is configured to select the second node group, so that an amount of data converted from the process execution time of the node of the selected first node group to exceed a threshold value is smaller than the amount of data converted from the process execution time of the node of the second node group, which is less than the threshold value.

3. The information processing apparatus according to claim 1,
wherein a combination of the plurality of combinations is a third node group that includes the first node group and one or more nodes of the plurality of nodes to which the processes of the first node group are allocated in an order from the node with calculated shortest process execution time among the remaining nodes.

4. The information processing apparatus according to claim 3,
wherein the processor is configured to:
select a fourth node group that includes a predetermined number of nodes in the order from the node with the calculated longest process execution time among the plurality of nodes;
select a fifth node group that includes one or more nodes of the plurality of nodes to which processes of the fourth node group are allocated among the remaining nodes excluding the fourth node group from the plurality of nodes;
calculate the sum of the process execution time in each of a plurality of combinations of the node of the fourth node group and the node of the fifth node group and the adjustment time that each of the plurality of processes is allocated to any one of the plurality of nodes;
repeat calculating the sum by increasing the predetermined number until the adjustment target is determined; and
when the calculated sum satisfies a predetermined condition, determine a combination of the plurality of combinations in which the calculated sum satisfies the predetermined condition, as the adjustment target.

5. The information processing apparatus according to claim 4,
wherein the processor is further configured to:
calculate a standard deviation of the longest process execution time and a standard deviation of the shortest process execution time;
set the predetermined number based on a result of comparison between the calculated standard deviation of the longest process execution time and the calculated standard deviation of the shortest process execution time; and
set an amount of increase in the predetermined number.

6. The information processing apparatus according to claim 1,
wherein the processor is configured to calculate the process execution time in each of the plurality of nodes when each of the plurality of processes is allocated to a node that has data to be used by the process among the plurality of nodes.

7. The information processing apparatus according to claim 1,
wherein the processor is configured to calculate the process execution time in each of the plurality of nodes, based on an amount of computation resource possessed by each of the plurality of nodes when each of the plurality of processes is allocated to a node that has data to be used by the process among the plurality of nodes.

8. A distributed processing system comprising:
a plurality of nodes; and
an information processing apparatus configured to allocate each of a plurality of processes to any one of a plurality of nodes, the information processing apparatus including:
a memory, and
a processor coupled to the memory and the processor configured to:
calculate a process execution time, for each of the plurality of nodes, in which one or more processes of the plurality of processes to be allocated to the node is performed in the node,
select a first node group that includes one or more nodes of the plurality of nodes in an order from the node with a calculated longest process execution time among the plurality of nodes,
select a second node group that includes one or more nodes of the plurality of nodes to which processes of the first node group are allocated among remaining nodes excluding the first node group from the plurality of nodes,
calculate a sum of the process execution time in each of a plurality of combinations of the node of the first node group and the node of the second node group and an adjustment time that each of the plurality of processes is allocated to any one of the plurality of nodes, and
determine any one of the plurality of combinations as an adjustment target, based on the sum calculated for each of the plurality of combinations.

9. A computer-readable non-transitory recording medium having stored therein a program that causes a computer to execute a procedure, the procedure comprising:
when each of a plurality of processes is allocated to any one of a plurality of nodes, calculating a process execution time, for each of the plurality of nodes, in which one or more processes of the plurality of processes to be allocated to the node is performed in the node;
selecting a first node group that includes one or more nodes of the plurality of nodes in an order from the node with a calculated longest process execution time among the plurality of nodes;
selecting a second node group that includes one or more nodes of the plurality of nodes to which processes of the first node group are allocated among remaining nodes excluding the first node group from the plurality of nodes;
calculating a sum of the process execution time in each of a plurality of combinations of the node of the first node group and the node of the second node group and an adjustment time that each of the plurality of processes is allocated to any one of the plurality of nodes; and
determining any one of the plurality of combinations as an adjustment target, based on the sum calculated for each of the plurality of combinations.
